(19) United States
(12) Patent Application Publication
(10) Pub. No.: US 2013/0100981 A1
(43) Pub. Date: Apr. 25, 2013

(54) SYSTEM AND METHOD OF DETECTING SUBLIMATION POINT

(71) Applicants: Tu LEE, Flushing, NY (US); Jwo-Huei Jou, Hsinchu City (TW); Meng-Hsun Tsai, Kaohsiung City (TW); Yu-Ren Syue, Kaohsiung City (TW)

(72) Inventors: Tu LEE, Flushing, NY (US); Jwo-Huei Jou, Hsinchu City (TW); Meng-Hsun Tsai, Kaohsiung City (TW); Yu-Ren Syue, Kaohsiung City (TW)

(21) Appl. No.: 13/399,468

(22) Filed: Feb. 17, 2012

(30) Foreign Application Priority Data
Oct. 24, 2011 (TW) 100138554

(51) Int. Cl. G01N 25/02

(52) U.S. Cl. 374/17

(57) ABSTRACT

The present invention provides a system and a method of detecting a sublimation point, preferably applied to organic molecules. The system of detecting a sublimation point comprises: a heater, a capillary device, a vacuum pump, an ultraviolet light source, a photography device, a digital vacuum meter and a needle valve. The system of detecting a sublimation point is suitable for detecting the sublimation point of an organic light emitting molecule such as tris(8-hydroxyquinolinato) aluminum (Alq₃) and tris(phenylpyridine) iridium (Ir(ppy)₃). The needle valve can be used for controlling air pressure to measure the sublimation point under different pressures. Advantageously, the required quantity of organic molecules can be below 1 mg, thus not only saving the organic molecules, but also detecting the sublimation point without contaminating apparatuses.

### FIELD OF THE INVENTION

This application claims priority from Taiwan Patent Application No. 100138554, filed on Oct. 24, 2011, in Taiwan Intellectual Property Office, the contents of which are hereby incorporated by reference in their entirety for all purposes.

### BACKGROUND OF THE INVENTION

In recent years, science and technology advance, so that the quality requirements for semiconductors and optoelectronic materials become increasingly higher, and the sublimation method and method for detecting sublimation points of semiconductors and optoelectronic materials becomes increasingly more important than ever. At present, existing methods for measuring sublimation points require a relative large quantity of samples. For example, a thermogravimetric analyzer (TGA) is an instrument used for detecting and measuring a sample material at a specific temperature. The principle of the thermogravimetric analyzer (TGA) primarily puts a sample into a furnace capable of increasing, decreasing or maintaining temperature through programs, and a fixed ambient gas (such as nitrogen or oxygen) is passed through the furnace, such that when the temperature rises to an evaporation temperature, a decomposition temperature or an oxidation temperature of a certain material composite, the sample will be evaporated, decomposed and oxidized to result in a loss of weight, and the change of weight of the sample varied with temperature or time is recorded, so as to determine the decomposition temperature, thermal stability, composition proportion, sample purity, water content, reduction temperature, sublimation temperature and anti-oxidation property of the material can be determined. Therefore, two major elements in TGA are a temperature control element and a weight measuring element. With a combination of the two, the change of weight at different temperatures is recorded. However, the required quantity of the sample is approximately equal to 3 mg. Since the quantity of the sample is very small, a larger waste of the sample will result. In addition, the sample may contaminate the instrument, thus causing tremendous inconvenience to users.

Wherein, the method of detecting a sublimation point of an organic molecule gains increasingly more attention, and the organic molecule includes an organic light emitting diode (OLED) material such as Alq₃ and Ir(ppy)₃. Particularly, The method and system only requiring a trace amount of sample for detecting the sublimation point not only reduces the waste of the sample, but also lower the cost.

However, conventional methods and systems for detecting a sublimation point of an organic molecule sublimation point as disclosed in R.O.C. Pat. No. TWI242463 provides both vertical and horizontal high-performance vacuum sublimation apparatus and method, which are only applicable for mass producing high-purity chemicals. R.O.C. Pat. Application No. TW200934576 discloses a quantitative sublimation and purification apparatus that fills a raw material and collects a product precisely, and different models of sublimation devices can be used to efficiently purify a special chemical by sublimation. U.S. Pat. No. 4,407,488 discloses an apparatus to solidify and deposit a gas, and then heat to sublimate the gas. The apparatus is primarily used for partitioning and purifying sample materials in different containers to achieve the separation and purification effects.

Obviously, the application of present existing sublimation apparatuses and methods thereof mainly adopt the separation and purification methods, but there is no disclosure of the method and apparatus for detecting the sublimation point of the organic molecule by a trace amount of the sample.

### SUMMARY OF THE INVENTION

It is a primary objective of the present invention to provide a system and method of detecting a sublimation point, particularly the system and method of detecting a sublimation point of a trace amount of organic molecules at different vacuum levels.

Another objective of the present invention is to detect a sublimation point and a heat of sublimation of an organic molecule at different vacuum levels quickly without contaminating apparatuses.

To achieve the aforementioned objectives, the present invention provides a system of detecting a sublimation point comprising: a heater, for heating an organic molecule, and the heater including a temperature display for displaying a temperature; a capillary device, installed on the heater, and including a plurality of capillaries, for carrying the organic molecule; a vacuum pump, coupled to the capillary device, for pumping air from the capillary device to lower an air pressure in the capillary device; an ultraviolet light source, for irradiating an ultraviolet light onto the capillary device, such that when the organic molecule is sublimed, a color change of the plurality of capillaries occurred after irradiating the ultraviolet light indicates that the organic molecule has reached a sublimation point.

Preferably, the system of detecting a sublimation point in accordance with the present invention further comprises: a digital vacuum meter, coupled to the vacuum pump and the capillary device, for displaying a vacuum level inside the capillary device; a needle valve, coupled to the digital vacuum meter, and the capillary device and the vacuum pump being used for regulating the air pressure in the capillary device; and a photography device, for recording a color change and a corresponding temperature of the plurality of capillaries during a heating process.

Preferably, the capillary device further includes a rubber cap and a capillary frame, wherein the rubber cap has a plurality of holes formed at positions corresponding to the plurality of capillaries respectively, and end opposite to the plurality of holes is coupled to the vacuum pump, and the rubber cap and the capillary frame are jointly provided for fixing the plurality of capillaries.

Preferably, the organic molecule includes an organic light emitting molecule.

Preferably, the organic light emitting molecule includes tris(8-hydroxyquinolinato) aluminum (Alq₃) or tris(phenylpyridine) iridium (Ir(ppy)₃).

Preferably, the system of detecting a sublimation point in accordance with the present invention can detect the heat of sublimation (ΔHsub) and the heat of melting (ΔHmelt) of the organic molecule.

The present invention further provides a method of detecting a sublimation point, and the method comprises the steps of: filling an organic molecule into a capillary of a capillary device; putting the capillary filled with the organic molecule on a heater; turning on a vacuum pump to pump air out of the capillary device; turning on the heater to heat the organic molecule; and irradiating an ultraviolet light source onto the capillary device, thereby a color change of the capillary indicates that the organic molecule has reached a sublimation point.

Preferably, the heater has a heating speed falling within a range of 5˜15° C. per minute.

Preferably, a needle valve is used for regulating the pressure within a range of 20 mmHg˜760 mmHg

In summation, the system and method of detecting a sublimation point in accordance with the present invention have one or more of the following advantages:

(1) The quantity of the organic molecule filled into the capillary can be less than 1 mg, not only saving the organic molecules, but also avoid contaminating the system of detecting a sublimation point in accordance with the present invention.

(2) The present invention uses less amount of sample to detect the sublimation point and the heat of sublimation (ΔHsub) in a shorter time, so that the invention can lower the costs.

(3) The present invention compares the difference of the sublimation points of the organic molecule at different vacuum levels, and such data become very important for evaporation devices.

The contents disclosed in the aforementioned prior art are provided for readers to understand the technical background of the present invention, but the contents do not obstruct this invention, and the contents are prior arts familiar to persons ordinarily skilled in the art.

### BRIEF DESCRIPTION OF THE DRAWINGS

FIG. 1 is a schematic view of a system of detecting a sublimation point of the present invention;

FIG. 2 is a flow chart of a method of detecting a sublimation point of the present invention;

FIG. 3A shows Alq3 attached to the capillary wall of the optical microscope diagram;

FIG. 3B is a weight percentage versus temperature loss graph of Alq₃ measured by a thermogravimetric analyzer (TGA);

FIG. 4 shows the results of ln P versus 1/T of a system of detecting a sublimation point of Alq₃ in accordance with the present invention; and

FIG. 5 is a curve showing the heat of sublimation (ΔHsub) and the heat of melting (ΔHmelt) of Alq₃ by using a differential scanning calorimeter (DSC).

### DESCRIPTION OF THE PREFERRED EMBODIMENTS

The technical characteristics of the present invention will become apparent with the detailed description of the preferred embodiments accompanied with the illustration of related drawings as follows. It is noteworthy to point out that same numerals are used for representing respective elements for the description of the preferred embodiments and the illustration of the drawings.

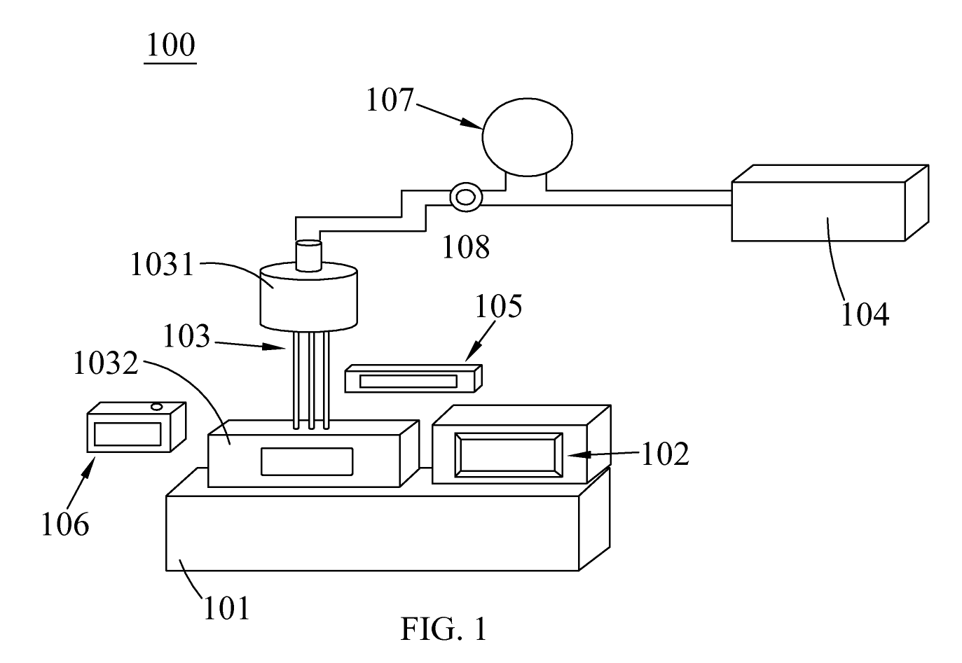

With reference to FIG. 1 for a schematic view of a system of detecting a sublimation point 100 in accordance with the present invention, the system of detecting a sublimation point 100 comprises a heater 101, a capillary device 103, a vacuum pump 104 and an ultraviolet light source 105.

The heater 101 for heating the organic molecule whose sublimation point is to be detected, and the heater 101 comprises a temperature display device 102 for displaying the temperature of a heating process. When the organic molecule is sublimed, the temperature display device 102 informs us about the temperature. The capillary device 103 is installed on the heater 101 and includes a plurality of capillaries for carrying the organic molecule to be heated. The vacuum pump 104 is coupled to the capillary device 103 through a Teflon tube for pumping air out of the capillary device 103 to reduce the air pressure in the capillary device 103. The ultraviolet light source 105 is provided for irradiate an ultraviolet light to the capillary device 103. When the organic molecule is sublimed, the ultraviolet light source 105 irradiates to discover any color change of the capillary, and the color change indicates that the organic molecule has reached a sublimation point.

In addition, the system of the present invention selectively adds a photography device 106, a digital vacuum meter 107 and a needle valve 108. The photography device 106 can record the color change of the capillary during the heating process and the corresponding temperature displayed by the temperature display device 102. Even if a user is not observing the color change at site, the user still can know that the organic molecule has reached the sublimation point. The digital vacuum meter 107 can be installed between the capillary device 103 and the vacuum pump 104 and coupled by the Teflon pipe for displaying the vacuum level. The needle valve 108 can be installed between the capillary device 103, the digital vacuum meter 107 and the vacuum pump 104 by the Teflon pipe for regulating the air pressure in the capillary device 103 after the vacuum pump 104 pumps the air out of the capillary device 103.

The weight of the organic molecules used for detection by the system of the present invention can be less than 1 mg, or a less amount of sample can be used for detecting the sublimation point to avoid wasting the sample or contaminating the system 100 of the present invention.

The organic molecule includes an organic light emitting molecule, and the organic light emitting molecule can be tris(8-hydroxyquinolinato) aluminum (Alq₃) or tris(phenylpyridine) iridium (Ir(ppy)₃), and whose light emitting property is used for observing the color change when the sublimation point is reached.

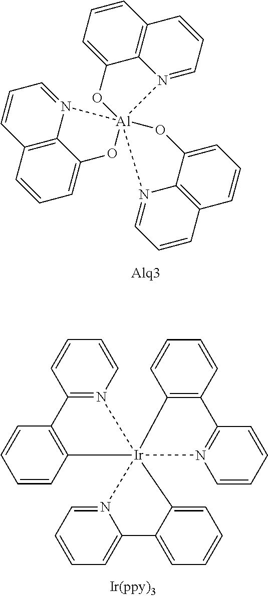

In addition, the capillary device 103 further includes a rubber cap 1031 and a capillary frame 1032, and an end of the rubber cap 1031 has a plurality of holes formed thereon and corresponding to the plurality of capillaries respectively, and the other end of the plurality of holes is coupled to the vacuum pump 104, and both ends of the rubber cap 1031 are interconnected, such that air can be pumped from the capillary by the vacuum pump 104. The capillary frame 1032 and the rubber cap 1031 are jointly provided for fixing the plurality of capillaries.

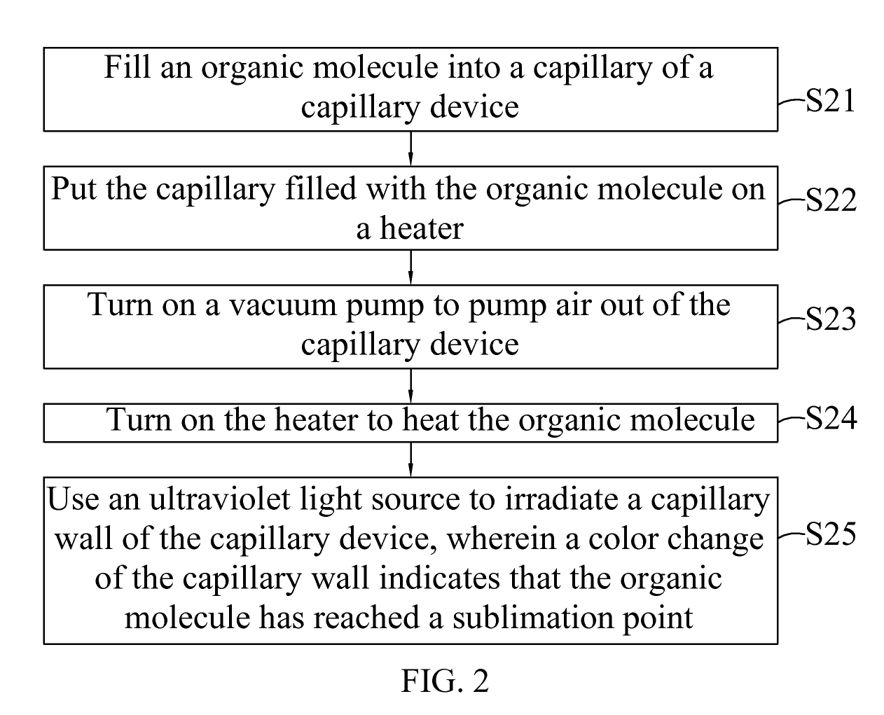

With reference to FIG. 2 for a flow chart of a method of detecting a sublimation point in accordance with the present invention, the method comprises the following steps:

S21: Fill organic molecules into a capillary of a capillary device.

S22: Put the capillary device filled with the organic molecules on a heater.

S23: Turn on a vacuum pump to pump air out of the capillary device.

S24: Turn on the heater to heat the organic molecules; and

S25: Use an ultraviolet light source to irradiate a capillary wall of the capillary device, wherein a color change of the capillary wall indicates that the organic molecule has reached a sublimation point.

After the step S21 takes place, a syringe needle is used to rinse a capillary wall by distilled water after the step of filling the organic molecule into the capillary of the capillary device takes place. The syringe needle can be used for rinsing the capillary wall by distilled water, so that the powder of the organic molecules will not remain on the capillary wall. After the step S23 takes place, if the digital vacuum meter reads 10⁻⁷ atm, the needle valve is shut, and then the vacuum pump is turned off. To improve the convenience of the observation, the photography device is provided for recording the color change of the capillary and its corresponding temperature during the heating process.

The organic molecule includes an organic light emitting molecule which can be Alq₃ or Ir(ppy)₃, and the heater is provided for heating the organic light emitting molecule at a speed of 5˜15° C. per minute, preferably 10° C. per minute.

Preferably, the needle valve is turned on to regulate the pressure of the capillary device to a pressure range of 20 mmHg˜760 mmHg. The weight of the organic molecule is less than 1 mg. If the organic molecule is heated to the sublimation point at different pressures, a misty organic molecule attached onto the capillary or a color change of the capillary indicates the sublimation points at different pressures. The present invention can compare the difference of the sublimation points of the organic molecule at different vacuum levels. For evaporation elements, these are necessary data.

To verify the data of the sublimation points measured by the system and method of detecting a sublimation point in accordance with the present invention, this embodiment uses Alq₃ as the organic molecule sample to measure the sublimation point and the heat of sublimation (ΔHsub), and a thermogravimetric analyzer (TGA) and a differential scanning calorimeter (DSC) to compare the measured data. It is noteworthy to point out that this embodiment adopts Alq₃ for the organic molecule, but the invention is not limited to Alq₃ only, and the sublimation point and the heat of sublimation (ΔHsub) of other organic molecules such as Ir(ppy)₃ can be used as well.

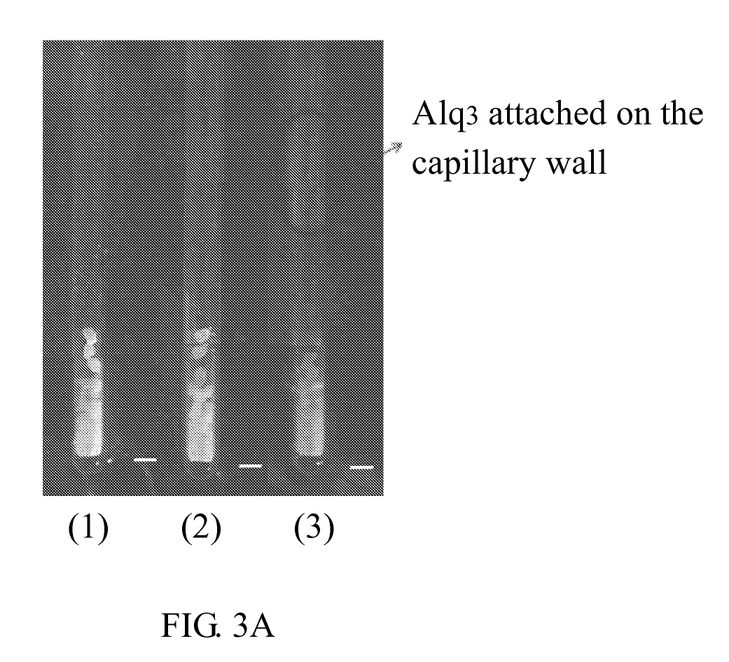

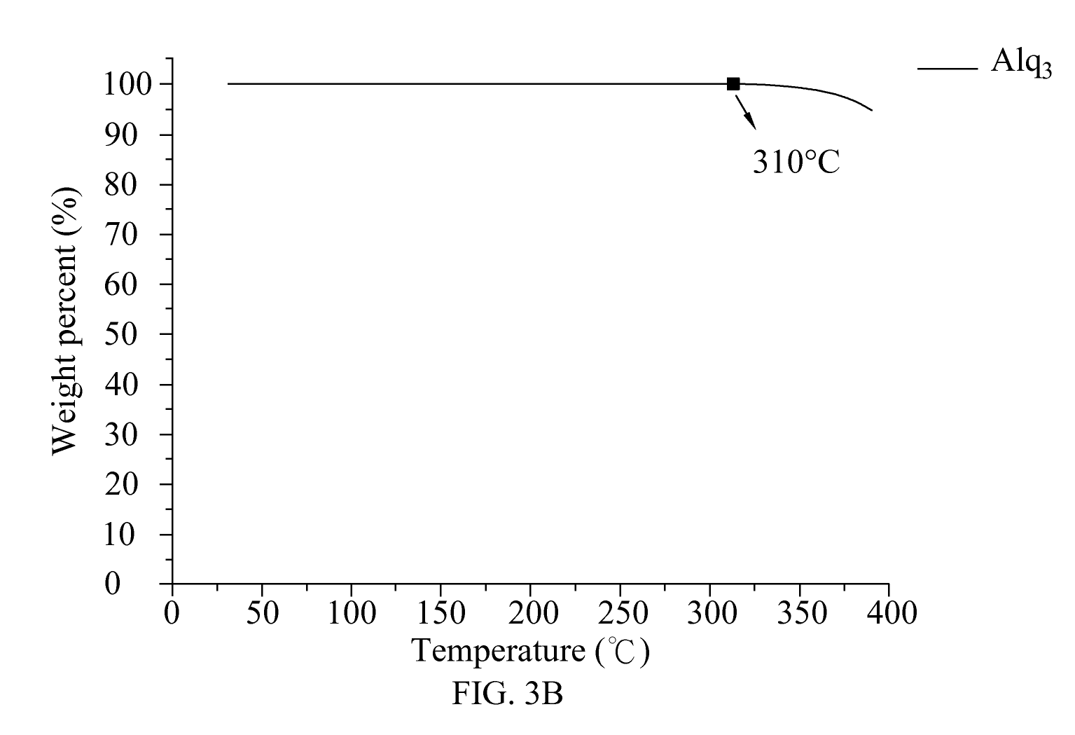

With reference to FIG. 3A for optical microscopic photos of a system of detecting a sublimation point in accordance with the present invention, a capillary of the system is provided for carrying the Alq₃. In the first capillary (1), the Alq₃ at an atmospheric pressure is filled into the capillary. In the second capillary (2), the Alq₃ at the atmospheric pressure is filled into the capillary, and then the syringe needle is used for rinsing the capillary wall by distilled water to clean any Alq₃ powder attached on the capillary wall. In the third capillary (3), the Alq₃ at the atmospheric pressure is filled into the capillary, and then heated to the sublimation point, until the Alq₃ is attached onto the capillary wall. The Alq₃ is an organic light emitting molecule at the atmospheric air pressure (760 mmHg). The method as shown in FIG. 2 is adopted, and it is found that the Alq₃ obviously reaches the sublimation point. The optical microscope shows that condensed particles of Alq₃ are attached onto the capillary wall of the third capillary (3) as shown in P1 of the figure. The sublimation point of the Alq₃ measured by the system of detecting a sublimation point of the present invention is approximately equal to 308° C. FIG. 3 shows a weight loss temperature of Alq₃ measured by the thermogravimetric analyzer (TGA), and FIG. 3B shows that the weight loss temperature of the Alq₃ is approximately equal to 310° C., so that the sublimation point of the Alq₃ measured by the system and method of detecting a sublimation point in accordance with the present invention is approximately equal to 310° C., which is very close to the sublimation point measured by the thermogravimetric analyzer (TGA), but the invention further has the advantage of using a sample with the quantity of less 1 mg to obtain the sublimation point.

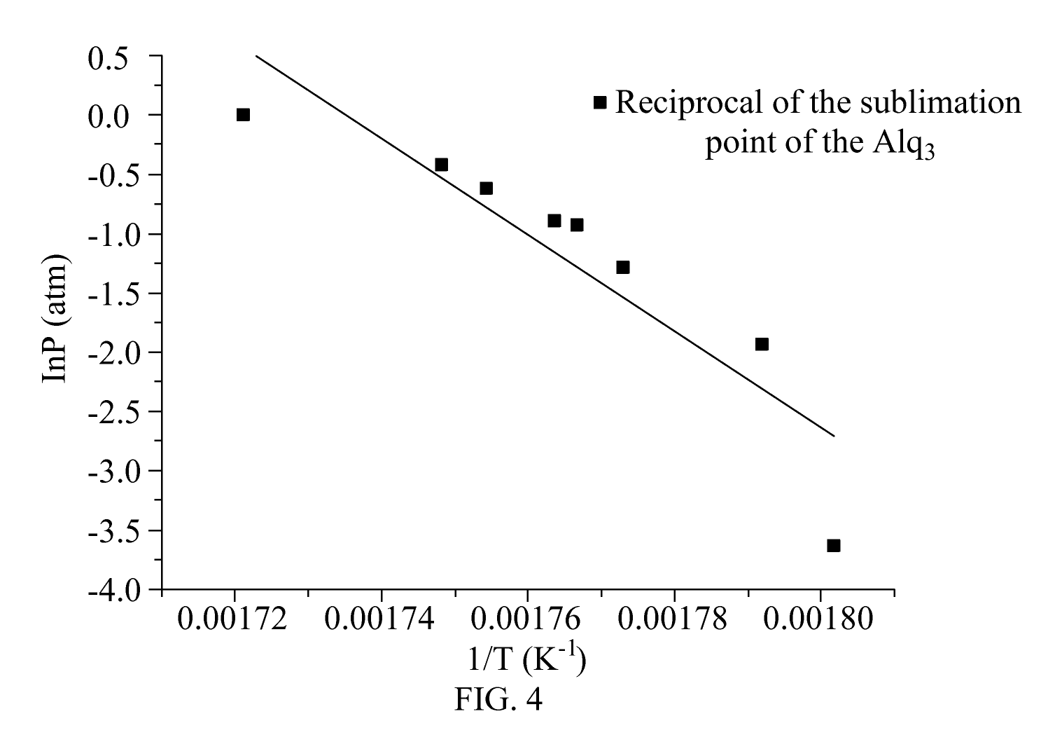

In addition, the sublimation point temperatures of the Alq₃ measured at the pressures of 20 mmHg, 110 mmHg, 210 mmHg, 300 mmHg, 310 mmHg, 410 mmHg, 500 mmHg and 760 mmHg are equal to 282° C., 285° C., 291° C., 293° C., 294° C., 297° C., 299° C. and 308° C. respectively, and then the pressure (P), the temperature (T), ln P and 1/T are used to create a table as shown in Table 1, and then a graph of ln P versus 1/T is plotted as shown in FIG. 4. From the figure, the slope is found to be equal to −40694.9058, and finally the data are substituted into the Clausius-Clapeyron equation (as shown in Equation (1)) to obtain the heat of sublimation (ΔHsub) which is equal to 736.4 J/g.

TABLE 1

| | | Sublimation | |
|---|---|---|---|
| Pressure (P) | lnP(atm) | Point (T) | 1/T (k-1) |
| 20 mmHg | −3.63759 | 555k | 0.001802 |
| 110 mmHg | −1.93284 | 558k | 0.001792 |
| 210 mmHg | −1.28621 | 564k | 0.001773 |
| 300 mmHg | −0.92954 | 566k | 0.001767 |
| 310 mmHg | −0.89675 | 567k | 0.001764 |
| 410 mmHg | −0.61716 | 570k | 0.001754 |
| 500 mmHg | −0.41871 | 572k | 0.001748 |
| 760 mmHg | 0 | 581k | 0.001721 |

ln P=(ΔHsub/R)×1/T (1)

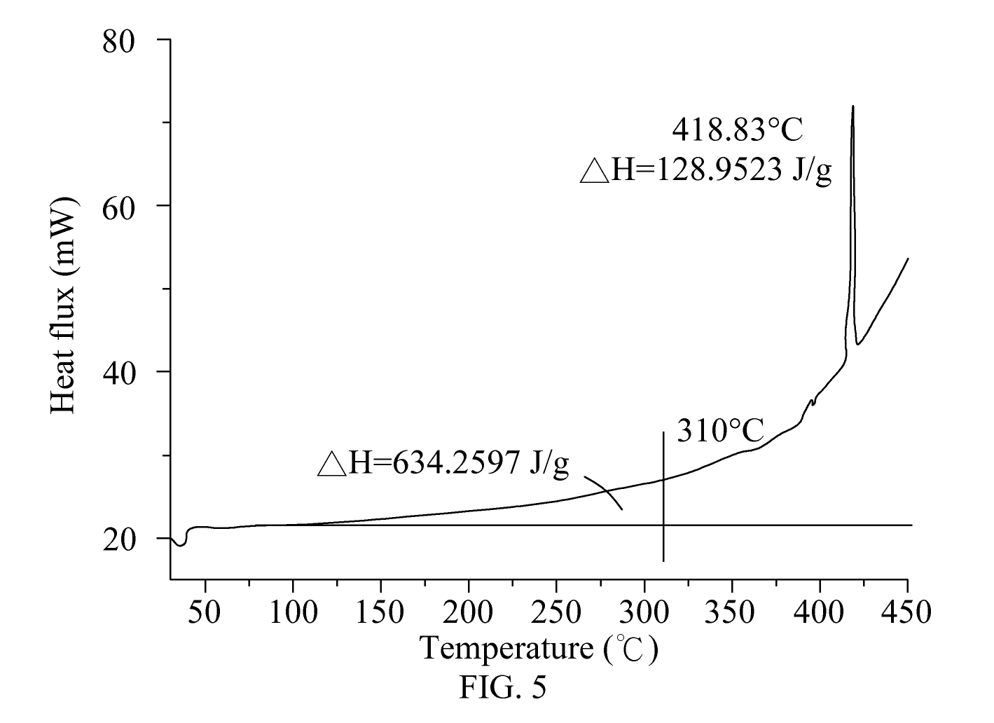

With reference to FIG. 5 for the heat of sublimation (ΔHsub) and the heat of melting (ΔHmelt) of Alq₃ by using a differential scanning calorimeter (DSC), the DSC is an instrument used for measuring an energy change of a sample material at a specific temperature condition. The main principle of the DSC is to put a sample into a heating furnace to increase, decrease or maintain the temperature through a program, and an ambient gas such as nitrogen or oxygen is passed. If the sample is evaporated, melted or crystallized to cause a phase change, the energy absorbed or discharged will vary accordingly, so that the energy varied with temperature or time can be used as a basis for determining the heat of reaction, melting point, glass transition temperature, crystallization temperature, specific heat, thermal stability, oxidation stability, crosslinking heat of reaction, and kinetic analysis of a material. In a detection, the heat of sublimation (ΔHsub) measured by the differential scanning calorimeter (DSC) is equal to 634.2597 J/g as shown in FIG. 5. Compared with the reading obtained from the system of detecting a sublimation point in accordance with the present invention, the error falls within an acceptable range. The detected peak as shown in FIG. 5 indicates that the melting point of the Alq₃ is equal to 418.83° C., and the heat of melting (ΔHmelt) is equal to 128.9523 J/g.

In summation, the sublimation point detected by the system and method of detecting a sublimation point in accordance with the present invention is close to the sublimation point detected by the thermogravimetric analyzer (TGA), and the amount used for the detection in the present invention is less. For a trace amount of the sample, a waste of sample can be avoided, and the system of detecting a sublimation point in accordance with the present invention will not be contaminated. In addition, the present invention can measure the sublimation points of the organic molecule at different pressures. For evaporation elements, each sublimation point serves as a necessary datum.

While the invention has been described by means of specific embodiments, numerous modifications and variations could be made thereto by those skilled in the art without departing from the scope and spirit of the invention set forth in the claims.

What is claimed is:

1. A system of detecting a sublimation point, comprising:
a heater, arranged for heating an organic molecule;
a capillary device, disposed on the heater, the capillary device comprising a plurality of capillaries, for carrying the organic molecule;
a vacuum pump, coupled to the capillary device, arranged for pumping air from the capillary device to lower an air pressure in the capillary device; and
an ultraviolet light source, arranged for irradiating an ultraviolet light onto the capillary device, such that when the organic molecule is sublimed, a color change of the plurality of capillaries induced after irradiating the ultraviolet light indicates that the organic molecule has reached the sublimation point.

2. The system of claim 1, further comprising a digital vacuum meter coupled to the vacuum pump and the capillary device for displaying a vacuum level inside the capillary device.

3. The system of claim 2, further comprising a needle valve, coupled to the digital vacuum meter, and the capillary device and the vacuum pump being used for regulating the air pressure in the capillary device.

4. The system of claim 1, wherein the heater further comprises a temperature display for displaying a temperature.

5. The system of claim 1, further comprising a photography device, arranged for recording the color change and a corresponding temperature of the plurality of capillaries during a heating process.

6. The system of claim 1, wherein the organic molecule includes an organic light emitting molecule.

7. The system of claim 6, wherein the organic light emitting molecule includes tris(8-hydroxyquinolinato) aluminum (Alq₃) or tris(phenylpyridine) iridium (Ir(ppy)₃).

8. The system of claim 1, wherein the capillary device further comprises:
a rubber cap, having a plurality of holes formed at an end of the rubber cap, and corresponding to the plurality of capillaries respectively, and the other end of the rubber cap opposite to the plurality of holes is coupled to the vacuum pump; and
a capillary support frame, together with the rubber cap, for fixing the plurality of capillaries.

9. A method of detecting a sublimation point, comprising the steps of:
filling an organic molecule into a capillary of a capillary device;
putting the capillary filled with the organic molecule on a heater;
turning on a vacuum pump to pump air out of the capillary device;
turning on the heater to heat the organic molecule; and
irradiating an ultraviolet light source onto the capillary device, thereby a color change of the capillary indicates that the organic molecule has reached the sublimation point.

10. The method of detecting a sublimation point as recited in claim 9, further comprising the step of using a syringe needle to rinse a capillary wall by distilled water after the step of filling the organic molecule into the capillary of the capillary device takes place.

11. The method of detecting a sublimation point as recited in claim 9, further comprising the steps of using a needle valve to adjust a pressure in the capillary, and using a digital vacuum meter to display a vacuum level in the capillary, after the step of turning on the vacuum pump to pump air out of the capillary device takes place.

12. The method of detecting a sublimation point as recited in claim 11, wherein the needle valve is used for regulating the pressure within a range of 20 mmHg˜760 mmHg.

13. The method of detecting a sublimation point as recited in claim 9, further comprising the step of using a photography device to record the color change and a corresponding temperature of the capillary during a heating process.

14. The method of detecting a sublimation point as recited in claim 9, wherein the heater has a heating speed falling within a range of 5˜15° C. per minute.

15. The method of detecting a sublimation point as recited in claim 9, wherein the amount of organic molecules filled into the capillary is below 1 mg.
